(19) United States
(12) Patent Application Publication
(10) Pub. No.: US 2015/0003746 A1
(43) Pub. Date: Jan. 1, 2015

(54) COMPUTING DEVICE AND FILE VERIFYING METHOD

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: CHUNG-I LEE, New Taipei (TW); DE-YI XIE, Shenzhen (CN); ZHI-QIANG YI, Shenzhen (CN); QIANG CHEN, Shenzhen (CN); MING-ZHU HE, Shenzhen (CN)

(21) Appl. No.: 14/315,506

(22) Filed: Jun. 26, 2014

(30) Foreign Application Priority Data
Jun. 27, 2013 (CN) 2013102613481

(51) Int. Cl. G06K 9/72

(52) U.S. Cl. CPC G06K 9/723
USPC 382/218

(57) ABSTRACT

A computing device recognizes text data from an image file using an optical character recognition (OCR). The computing device processes the recognized text data using a fault-tolerant lexicon to extract key text. The computing device verifies that text data of a text file match the text data of the image file, upon the condition that the text data of the text file comprises the key text.

### FIELD

Embodiments of the present disclosure relate to data processing technology, and particularly to a computing device and a file verifying method.

### BACKGROUND

For better understanding of a technical file (e.g., a patent file), the technical file does not only include a specification described by words, but also includes one or more figures. Each figure includes a description. For example, the figure includes one or more number references or words so that the description in the specification can describe more effectively. However, if the description in the figures does not match the description in the specification, the technical file is not clear and may confuse the reader.

### BRIEF DESCRIPTION OF THE DRAWINGS

FIG. 1 is a block diagram of one embodiment of a computing device.

FIG. 2 is a flowchart illustrating one embodiment of a file verifying method.

FIG. 3 illustrates a displayed image corresponding to an image file.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The term “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

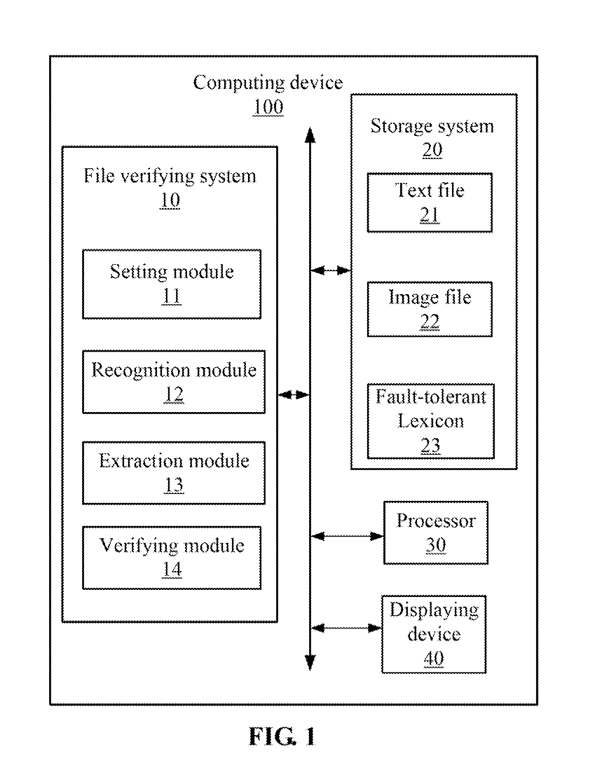

FIG. 1 is a block diagram of one embodiment of a computing device. The computing device 100 can be, but is not limited to, a personal computer (PC), a server, a tablet computer, a smart mobile phone, a thin computing device or any other devices.

The computing device 100 includes a file verifying system 10. In one embodiment, the file verifying system 10 includes a setting module 11, a recognition module 12, an extraction module 13, and a verifying module 14. The modules 11-14 can include computerized code in the form of one or more programs that are stored in a storage system 20 of the computing device 100. The computerized code includes instructions that are executed by the at least one processor 30 of the computing device 100 to provide functions for modules 11-14. The storage system 20 can be a memory chip, a hard disk drive, or a flash memory stick, for example. The computing device 100 further includes a displaying device 40.

The storage system 20 includes a text file 21, an image file 22 and a fault-tolerant lexicon 23. The text file 21 can be, but is not limited to, a WORD file, or a TXT file. The image file 22 can be, but is not limited to, a portable document format (PDF) file, a tagged image file format (TIFF) file, a portable network graphics (PNG) file, a graphics interchange format (GIF) file, a joint photographic experts group (JPEG) file. The fault-tolerant lexicon 23 includes one or more original characters and replacement characters in a table as shown below. Each original character is related to one replacement character. For example, the original character “I” is related to the replacement character “1”. The relation between the original character and the replacement character is predetermined by a user. The fault-tolerant lexicon 23 is used to correct errors when the computing device 100 recognizes characters from the image file 22. In essence, the fault-tolerant lexicon 23 keeps the recognized characters to be accurate in the presence of faults. For example, if the original character in the image file is “1”, however, the computing device 100 mistakenly recognizes the character “1” to be “I”, then the recognized character “I” is replaced by the replacement character “1” using the fault-tolerant lexicon 23. That is, if the recognized character is same as the original character in the fault-tolerant lexicon 23, and the recognized character is replaced by the replacement character in the fault-tolerant lexicon 23.

| Original character | Replacement character |
|---|---|
| I | 1 |
| O | 0 |
| Q | 9 |
| Z | 2 |

The setting module 11 sets a first rule for extracting text data from the image file 22 and a second rule for verifying text data of the text file 21. The text data mentioned above includes characters.

The first rule includes positions of the characters in image file 22 which are recognized by the computing device 100. The first rule further includes types of the characters in the image file 22 which are recognized by the computing device 100. The types of the characters can be, but are not limited to, numbers character, letters, Chinese characters, punctuation characters. If the first rule includes numbers which the computing device 100 recognizes, the computing device 100 recognizes numbers from the image file 22.

The second rule includes positions of the characters in text file 21 which are verified by the computing device 100. The second rule further includes types of the characters in the text file 21 which are verified by the computing device 100. The types of the characters can be, but are not limited to, numbers character, letters, Chinese characters, punctuation characters. If the second rule includes numbers which are verified by the computing device 100, the computing device 100 recognizes numbers from the text file 21.

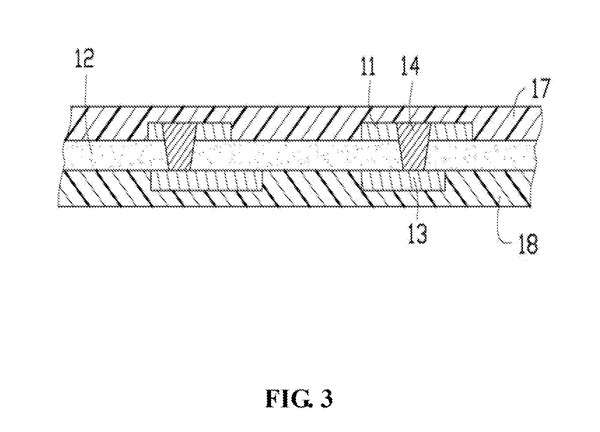

The recognition module 12 recognizes the text data from the image file 22 using an optical character recognition (OCR) according to the first rule. In one embodiment, the recognition module 12 recognizes the text data as “12 1i 14 17\n13 18” from FIG. 3.

The extraction module 13 processes the recognized text data using the fault-tolerant lexicon 23 to extract key text. In one embodiment, if the character in the recognized text data matches the original character in the fault-tolerant lexicon 23, the character in the recognized text data is replaced by the replacement character in the fault-tolerant lexicon 23. For example, the text data are “12 1i 14 17\n13 18”, the character “i” in the text data is replaced by the replacement character “1” in the fault-tolerant lexicon 23, and the text data are changed to be “12 11 14 17\n13 18”. According to the first rule, the extraction module 13 extracts numbers, then the text data are further changed to be “12 11 14 17 13 18” by filtering the characters “\n”. The changed text data are the key text which includes six numbers.

The verifying module 14 verifies that the text data of the text file 21 match the text data of the image file 22, upon the condition that the text data of the text file 21 includes the key text according to the second rule. In one embodiment, the verifying module 14 searches the key text in the text data of the text file 21 according to the second rule, if the text data of the text file 21 includes the key text, the text data of the text file 21 match the text data of the image file 22. Otherwise, if the text data of the text file 21 does not include the key text, the text data of the text file 21 does not match the text data of the image file 22, and the verifying module 14 displays a notification in the displaying device 40 of the computing device 100. The notification indicates that the text data of the text file 21 does not match the text data of the image file 22. Assuming that the text file 21 is a specification of a patent file, and the image file 22 is a drawing of the patent file as shown in FIG. 3, and the text file 21 describes the FIG. 3 in a description. If the text file 21 does not include all of the reference numbers “12 11 14 17 13 18”, for example, the text file 21 includes “12 11 14 17”, the text file 21 does not correctly describe the FIG. 3, and the text data of the text file 21 does not match the text data of the image file 22. If the text file 21 includes all of the reference numbers “12 11 14 17 13 18”, the text data of the text file 21 match the text data of the image file 22.

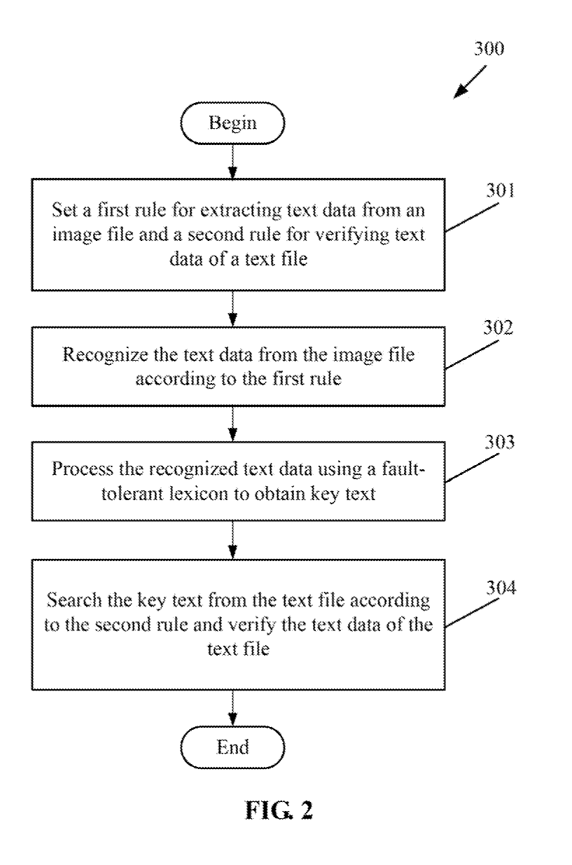

FIG. 2 is a flowchart illustrating one embodiment of a file verifying method. Depending on the embodiment, additional steps can be added, others deleted, and the ordering of the steps can be changed. The method 300 is provided by way of example, as there are a variety of ways to carry out the method. The method 300 described below can be carried out using the configurations illustrated in FIGS. 1 and 2, for example, and various elements of these figures are referenced in explaining method 300. Each block shown in FIG. 2 represents one or more processes, methods or subroutines, carried out in the exemplary method 300. Additionally, the illustrated order of blocks is by example only and the order of the blocks can change according to the present disclosure. The exemplary method 300 can begin at block 301.

At block 301, the setting module sets a first rule for extracting text data from the image file and a second rule for verifying text data of the text file. The text data mentioned above includes characters.

The first rule includes positions of the characters in image file where the computing device recognizes, and types of the characters in the image file which the computing device recognizes. The computing device can recognize the characters according to the according to the first rule. For example, if the image file is a drawing of a patent file as shown in FIG. 3, the first rule can direct the computing device to recognize the numbers.

The second rule includes positions of the characters in text file which are verified by the computing device, and types of the characters in the text file which are verified by the computing device. For example, if the text file is a specification of a patent file, the second rule can direct the computing device to search for the numbers which is positioned in a section of DD in the specification.

At block 302, the recognition module recognizes the text data from the image file using an optical character recognition (OCR) according to the first rule. In one embodiment, the text data are recognized as “12 1i 14 17\n13 18” from FIG. 3 using the OCR.

At block 303, the extraction module processes the recognized text data using the fault-tolerant lexicon to extract key text. For example, the character “i” in the text data is replaced by the replacement character “1” in the fault-tolerant lexicon, and the text data are changed to be “12 11 14 17\n13 18”. According to the first rule, the extraction module extracts numbers, then the text data are further changed to be “12 11 14 17 13 18” by filtering the characters “\n”. The changed text data are the key text which includes six numbers.

At block 304, the verifying module verifies that the text data of the text file match the text data of the image file, upon the condition that the text data of the text file includes the key text according to the second rule. Assuming that the text file is a specification of a patent file, and the image file is a drawing of the patent file as shown in FIG. 3, and the text file describes the FIG. 3 in a description. If the text file does not include all of the reference numbers “12 11 14 17 13 18”, for example, the text file includes “12 11 14 17”, the text file does not correctly describe the FIG. 3, and the text file does not match the image file. If the text file includes all of the reference numbers “12 11 14 17 13 18”, the text data of the text file match the text data of the image file.

Although certain inventive embodiments of the present disclosure have been specifically described, the present disclosure is not to be construed as being limited thereto. Various changes or modifications may be made to the embodiments of present disclosure without departing from the scope of the following claims.

What is claimed is:

1. A computing device, comprising:
at least one processor;
a storage system that stores an image file and a text file; and
the storage system that further stores one or more programs, which when executed by the at least one processor, cause the at least one processor to:
set a first rule for extracting text data from the image file and a second rule for verifying text data of the text file;
recognize the text data from the image file using an optical character recognition (OCR) according to the first rule;
process the recognized text data using a fault-tolerant lexicon to extract key text; and
verify the text data of the text file to match the text data of the image file, upon the condition that the text data of the text file comprises the key text according to the second rule.

2. The computing device of claim 1, wherein the text data of the image file comprise characters, and the first rule comprises positions of the characters in image file where the computing device recognizes, and types of the characters in the image file which the computing device recognizes.

3. The computing device of claim 1, wherein the text data of the text file comprise characters, and the second rule comprises positions of the characters in text file where the computing device verifies, and types of the characters in the text file which the computing device verifies.

4. The computing device of claim 1, wherein the fault-tolerant lexicon comprises original characters and replacement characters in a table, and each original character is related to one replacement character.

5. The computing device of claim 4, wherein the character in the recognized text data is replaced by the replacement character in the fault-tolerant lexicon, upon the condition that the character in the recognized text data matches the original character in the fault-tolerant lexicon.

6. A file verifying method in a computing device, the file verifying method comprising:
setting a first rule for extracting text data from an image file and a second rule for verifying text data of a text file, the image file and the text file being stored in the computing device;
recognizing the text data from the image file using an optical character recognition (OCR) according to the first rule;
processing the recognized text data using a fault-tolerant lexicon to extract key text; and
verifying that the text data of the text file match the text data of the image file, upon the condition that the text data of the text file comprises the key text according to the second rule.

7. The file verifying method of claim 6, wherein the text data of the image file comprise characters, and the first rule comprises positions of the characters in image file where the computing device recognizes, and types of the characters in the image file which the computing device recognizes.

8. The file verifying method of claim 6, wherein the text data of the text file comprise characters, and the second rule comprises positions of the characters in text file where the computing device verifies, and types of the characters in the text file which the computing device verifies.

9. The file verifying method of claim 6, wherein the fault-tolerant lexicon comprises original characters and replacement characters in a table, and each original character is related to one replacement character.

10. The file verifying method of claim 9, wherein the character in the recognized text data is replaced by the replacement character in the fault-tolerant lexicon, upon the condition that the character in the recognized text data match the original character in the fault-tolerant lexicon.

11. A non-transitory computer-readable medium having stored thereon instructions that, when executed by at least one processor of a computing device, causing the computing device to perform a file verifying method, the method comprising:
setting a first rule for extracting text data from an image file and a second rule for verifying text data of a text file, the image file and the text file being stored in the computing device;
recognizing the text data from the image file using an optical character recognition (OCR) according to the first rule;
processing the recognized text data using a fault-tolerant lexicon to extract key text; and
verifying that the text data of the text file match the text data of the image file, upon the condition that the text data of the text file comprises the key text according to the second rule.

12. The non-transitory computer-readable medium of claim 11, wherein the text data of the image file comprise characters, and the first rule comprises positions of the characters in image file where the computing device recognizes, and types of the characters in the image file which the computing device recognizes.

13. The non-transitory computer-readable medium of claim 11, wherein the text data of the text file comprise characters, and the second rule comprises positions of the characters in text file where the computing device verifies, and types of the characters in the text file which the computing device verifies.

14. The non-transitory computer-readable medium of claim 11, wherein the fault-tolerant lexicon comprises original characters and replacement characters in a table, and each original character is related to one replacement character.

15. The non-transitory computer-readable medium of claim 14, wherein the character in the recognized text data is replaced by the replacement character in the fault-tolerant lexicon, upon the condition that the character in the recognized text data match the original character in the fault-tolerant lexicon.
